(19) United States
(12) Patent Application Publication
(10) Pub. No.: US 2012/0188520 A1
(43) Pub. Date: Jul. 26, 2012

(54) OPTICAL ELEMENT AND PROJECTION DISPLAY APPARATUS

(75) Inventors: Sosuke Otani, Nara-City (JP); Makoto Maeda, Nara City (JP)

(73) Assignee: SANYO ELECTRIC CO., LTD., Osaka (JP)

(21) Appl. No.: 13/310,984

(22) Filed: Dec. 5, 2011

(30) Foreign Application Priority Data
Jan. 26, 2011 (JP) 2011-014471

(51) Int. Cl. G02B 27/14; G03B 21/14

(52) U.S. Cl. 353/84; 359/634

(57) ABSTRACT

An optical element includes: a first dichroic mirror; and a pair of second dichroic mirrors, wherein the first dichroic mirror includes a first mirror surface and a first main surface; the pair of second dichroic mirrors each includes a second mirror surface and a second main surface; one second dichroic mirror of the pair of second dichroic mirrors is disposed on the first mirror surface in such a way that the second mirror surface is perpendicular to the first mirror surface; the other second dichroic mirror of the pair of second dichroic mirrors is disposed on the first main surface in such a way that the second mirror surface is perpendicular to the first main surface; and a gradation process for adjusting a spectral characteristic within the first mirror surface is applied only for the first mirror surface.

### CROSS REFERENCE TO RELATED APPLICATIONS

This application is based upon and claims the benefit of priority from prior Japanese Patent Application No. 2011-014471 filed on Jan. 26, 2011; the entire content of which is incorporated herein by reference.

### BACKGROUND OF THE INVENTION

1. Field of the Invention

The present invention relates to an optical element and a projection display apparatus by which color component light is separated or combined.

2. Description of the Related Art

Conventionally, there is known a projection display apparatus configured to combine red component light, green component light, and blue component light by a color combining unit and to modulate each color component light by an imager such as a liquid crystal panel and a DMD (Digital Micromirror Device). The color combining unit is configured by a dichroic mirror, for example, which reflects one color component light beam and transmits the other color component light beams.

Generally, a dichroic mirror has a predetermined angle of gradient (for example, 46 degrees) with respect to an optical axis of the color component light. Therefore, an angle at which color component light enters the dichroic mirror differs according to the incidence position of the color component light in the dichroic mirror.

On the other hand, a cutoff wavelength shifts in accordance with the incidence angle of the color component light, and therefore, it is not possible to appropriately combine or separate the color component light. Therefore, in order to adjust the difference in the incidence angle of color component light, there is known a dichroic mirror of which the film thickness is adjusted in accordance with the incidence position (incidence angle) of the color component light (for example, Japanese Unexamined Patent Application Publication No. 2009-186704).

At the same time, there is also known a cross dichroic cube in which two types of dichroic mirrors are combined in such a way that these mirrors cross. Specifically, in the cross dichroic cube, a pair of second dichroic mirrors is adhered to a first dichroic mirror. For details, one of the second dichroic mirrors is adhered to a first main surface of the first dichroic mirror, and the other one of the second dichroic mirrors is adhered to a second main surface of the first dichroic mirror.

However, if the film thickness of the dichroic mirror is adjusted for both the first dichroic mirror and the second dichroic mirror, then the cost of the cross dichroic cube will be increased.

### SUMMARY OF THE INVENTION

An optical element (cross dichroic mirror 20) according to a first feature includes: a first dichroic mirror (first dichroic mirror 610); and a pair of second dichroic mirrors (second dichroic mirrors 620). The first dichroic mirror includes a first mirror surface (first mirror surface 611) that reflects first color component light and transmits second color component light, and a first main surface (first main surface 612) arranged on the opposite side of the first mirror surface. The pair of second dichroic mirrors each includes a second mirror surface (second mirror surface 621) that reflects third color component light and transmits the second color component light, and a second main surface (second main surface 622) arranged on the opposite side of the second mirror surface. One second dichroic mirror of the pair of second dichroic mirrors is disposed on the first mirror surface in such a way that the second mirror surface is perpendicular to the first mirror surface. The other second dichroic mirror of the pair of second dichroic mirrors is disposed on the first main surface in such a way that the second mirror surface is perpendicular to the first main surface. A gradation process for adjusting a spectral characteristic within the first mirror surface is applied only for the first mirror surface.

In the first feature, an interval between a waveband of the first color component light and a waveband of the second color component light is smaller than an interval between a waveband of the third color component light and the waveband of the second color component light.

A projection display apparatus according to a second feature includes the optical element according to the first feature.

In the second feature, a light source that outputs the second color component light is disposed more closely to the optical element than a light source that outputs the first color component light and the third color component light.

### BRIEF DESCRIPTION OF THE DRAWINGS

FIG. 1 is a diagram illustrating an overview of a projection display apparatus 100 according to a first embodiment;

FIG. 2 is a diagram illustrating an overview of the projection display apparatus 100 according to the first embodiment;

FIG. 3 is a diagram illustrating the details of the projection display apparatus 100 according to the first embodiment;

FIG. 4 is a diagram illustrating the details of the projection display apparatus 100 according to the first embodiment;

FIG. 5 is a diagram illustrating the details of a cooling unit 400 according to the first embodiment;

FIG. 6 is a diagram illustrating the details of a cross dichroic mirror 20 according to the first embodiment; and

FIG. 7 is a diagram illustrating an arrangement of a light source 10 according to the first embodiment.

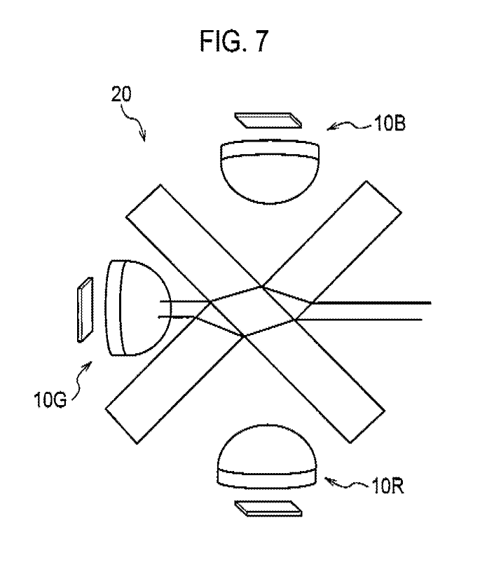

### MODES FOR CARRYING OUT THE INVENTION

Hereinafter, a projection display apparatus according to an embodiment of the present invention is described with reference to drawings. Note that in the descriptions of the drawing below, identical or similar symbols are assigned to identical or similar portions.

However, it should be noted that the drawings are schematic and ratios of respective dimensions and the like are different from actual ones. Therefore, the specific dimensions, etc., should be determined in consideration of the following explanations. Of course, among the drawings, the dimensional relationship and the ratio are different.

### OVERVIEW OF EMBODIMENT

The optical element according to the embodiment includes a first dichroic mirror and a pair of second dichroic mirrors. The first dichroic mirror includes: a first mirror surface that reflects first color component light and transmits second color component light; and a first main surface arranged on the opposite side of the first mirror surface. The pair of second dichroic mirrors each include: a second mirror surface that reflects third color component light and transmits the second color component light; and a second main surface arranged on the opposite side of the second mirror surface. One second dichroic mirror of the pair of second dichroic mirrors is disposed on the first mirror surface in such a way that the second mirror surface is perpendicular to the first mirror surface. The other second dichroic mirror of the pair of second dichroic mirrors is disposed on the first main surface in such a way that the second mirror surface is perpendicular to the first main surface. A gradation process for adjusting a spectral characteristic within the first mirror surface is applied only for the first mirror surface.

In the embodiment, the gradation process is not applied for the second mirror surface, but applied only for the first mirror surface. Therefore, the color component light can be combined or separated while inhibiting the rising cost.

In the embodiment, the first mirror surface, for which the gradation process is applied, is a non-separated mirror surface. Therefore, the gradation process is easy.

### First Embodiment

### Overview of Projection Display Apparatus

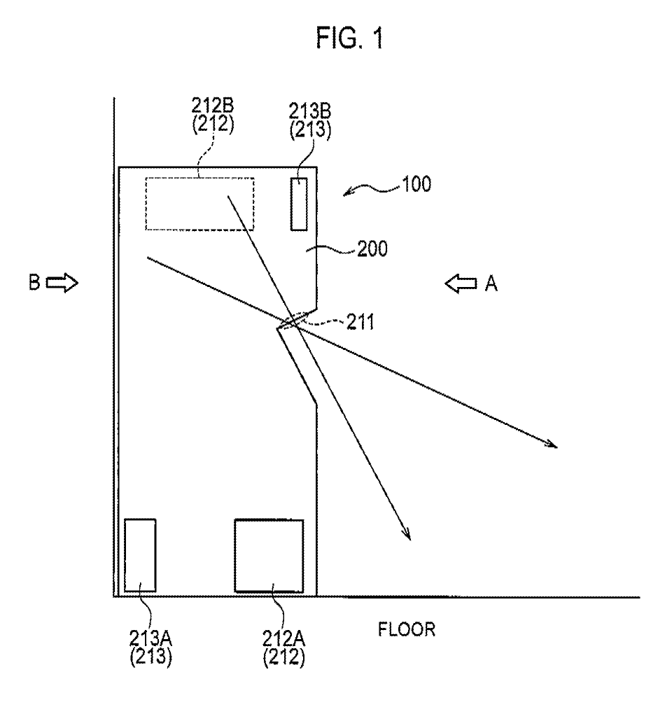

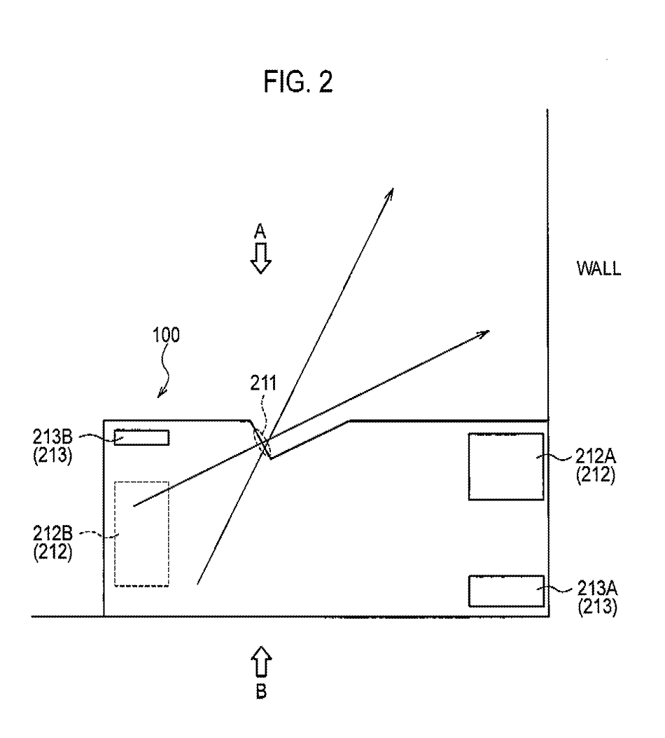

Hereinafter, an overview of a projection display apparatus according to a first embodiment is described with reference to drawings. FIG. 1 is a diagram illustrating a projection display apparatus 100 (floor surface projection) according to the first embodiment. FIG. 2 is a diagram illustrating the projection display apparatus 100 (wall surface projection) according to the first embodiment.

As illustrated in FIG. 1 and FIG. 2, the projection display apparatus 100 has a housing member 200 and projects an image onto the projection surface (not shown). The projection surface may be provided on the floor surface as illustrated in FIG. 1, or may be provided on the wall surface as illustrated in FIG. 2.

Note that a transparent region 211 through which image light passes is provided in the housing member 200. The housing member 200 includes an inlet 212 (an inlet 212A and an inlet 212B) and an outlet 213 (an outlet 213A and an outlet 213B).

### (Details of Projection Display Apparatus)

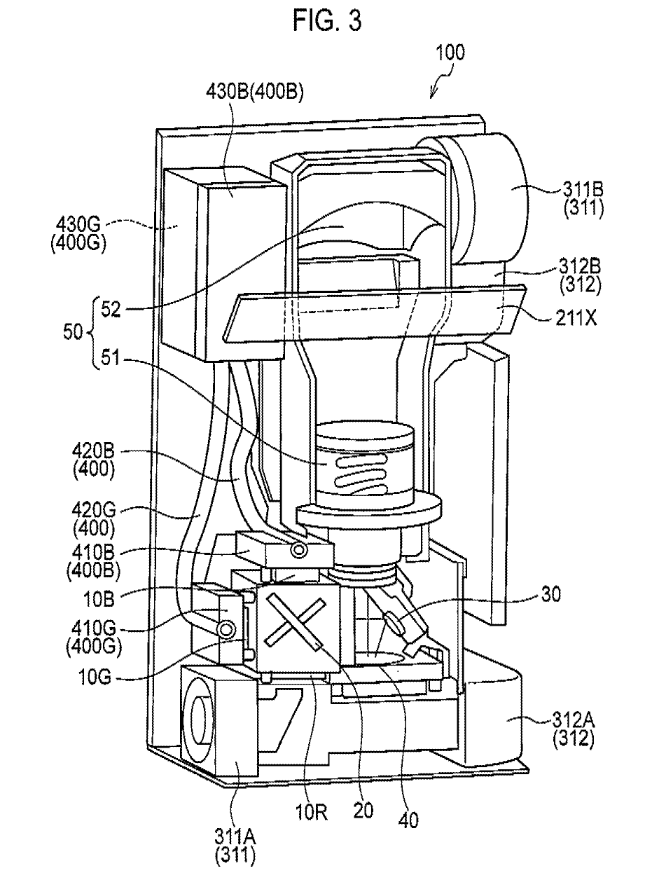

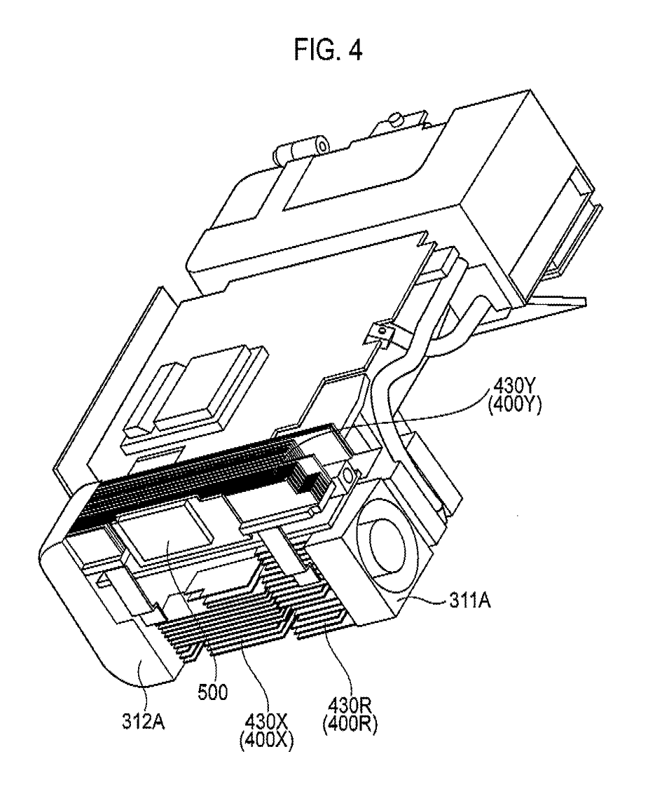

In the following, the details of the projection display apparatus 100 according to the first embodiment are described with reference to the drawings. FIG. 3 and FIG. 4 are diagrams illustrating the details of the projection display apparatus 100. FIG. 3 is a perspective view in which the projection display apparatus 100 illustrated in FIG. 1 and FIG. 2 is viewed from an A direction (front view). FIG. 4 is a perspective view in which the projection display apparatus 100 illustrated in FIG. 3 is viewed from a B direction (rear view). Note that in FIG. 3 and FIG. 4, the housing member 200 is depicted in a see-through manner and the internal configuration of the projection display apparatus 100 is illustrated.

As illustrated in FIG. 3 and FIG. 4, the projection display apparatus 100 includes a light source 10 (a light source 10R, a light source 10G, and a light source 10B), a cross dichroic mirror 20, a turning mirror 30, a DMD 40, and a projection unit 50.

The light source 10R is a light source from which red component light R emits, and is a red Light Emitting Diode (LED) or a red Laser Diode (LD), for example. The light source 10G is a light source from which green component light G emits, and is a green LED or a green LD, for example. The light source 10B is a light source from which blue component light B emits, and is a blue LED or a blue LD, for example.

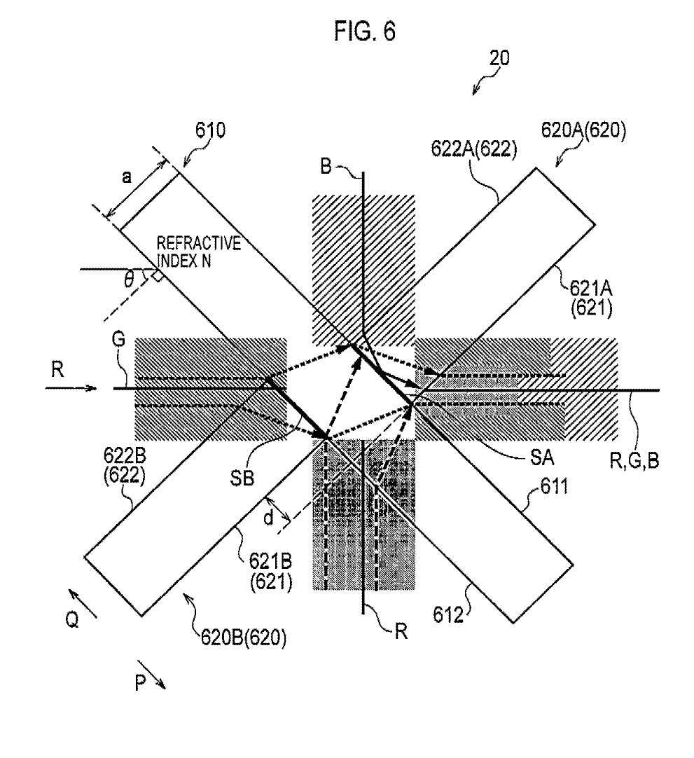

The cross dichroic mirror 20 transmits the green component light G that emitted from the light source 10G and reflects the blue component light B that emitted from the light source 10B. Moreover, the cross dichroic mirror 20 transmits the green component light G and reflects the red component light R that emitted from the light source 10R. Note that the details of the cross dichroic mirror 20 are described later (see FIG. 6).

The turning mirror 30 reflects the color component light that emitted from the cross dichroic mirror 20, toward the DMD 40 side.

The DMD 40 is formed of a plurality of micromirrors, and each of micromirror is movable. The DMD 40 switches between reflection and non-reflection of the light, which is reflected by the turning mirror 30, to the projection unit 50 by changing the angle of each minute mirror.

It should be noted that the center of the DMD 40 is shifted from an optical axis of the projection unit 50. Specifically, the center of the DMD 40 is shifted from the optical axis of the projection unit 50 toward the B direction illustrated in FIG. 2 (that is, toward a projection area side of the image light).

The projection unit 50 projects the image light that emitted from the DMD 40 onto the projection surface. For example, the projection unit 50 has a projection lens group 51 and a reflection mirror 52.

The projection lens group 51 outputs the image light that emitted from the DMD 40, toward the reflection mirror 52. The projection lens group 51 includes a lens of an approximately circular shape around the optical axis of the projection unit 50 and a lens of a shape configured by one portion of an approximately circular shape (for example, a lower half semicircular shape) around the optical axis of the projection unit 50.

It should be noted that the diameter of the lenses included in the projection unit 50 is larger as it is closer to the reflection mirror 52.

The reflection mirror 52 reflects the image light that emitted from the DMD 40, toward the projection surface. For example, the reflection mirror 52 is an aspherical mirror having a concave surface on the DMD 40 side.

Returning to FIG. 3 and FIG. 4, the projection display apparatus 100 has a fan 311 (a fan 311A and a fan 311B) and a duct 312 (a duct 312A and a duct 312B).

The fan 311 creates an airflow from the inlet 212 toward the outlet 213 in the airflow path formed by the duct 312. Specifically, the fan 311A guides an outside air of the housing member 200 from the inlet 212A toward the inside of the duct 312A. The fan 311B guides an outside air of the housing member 200 from the inlet 212A toward the inside of the duct 312B.

The duct 312 creates an airflow path from the inlet 212 toward the outlet 213. Note that the duct 312 may create only a part of the airflow path. Specifically, the duct 312A creates the airflow path from the inlet 212A toward the outlet 213A. Moreover, the duct 312B creates an airflow path from the inlet 212B toward the outlet 213B.

The projection display apparatus 100 has a cooling unit 400 (a cooling unit 400R, a cooling unit 400G, a cooling unit 400B, a cooling unit 400X, and a cooling unit 400Y).

The cooling unit 400R cools the light source 10R. In the first embodiment, the cooling unit 400R is a cooling fin 430R.

The cooling unit 400G cools the light source 10G. The cooling unit 400B cools the light source 10B. The cooling unit 400G and the cooling unit 400B include a heat receiving portion 410 (a heat receiving portion 410G and a heat receiving portion 410B), a heat pipe 420 (a heat pipe 420G and a heat pipe 420B), and a cooling fin 430 (a cooling fin 430G and a radiation fin 430B).

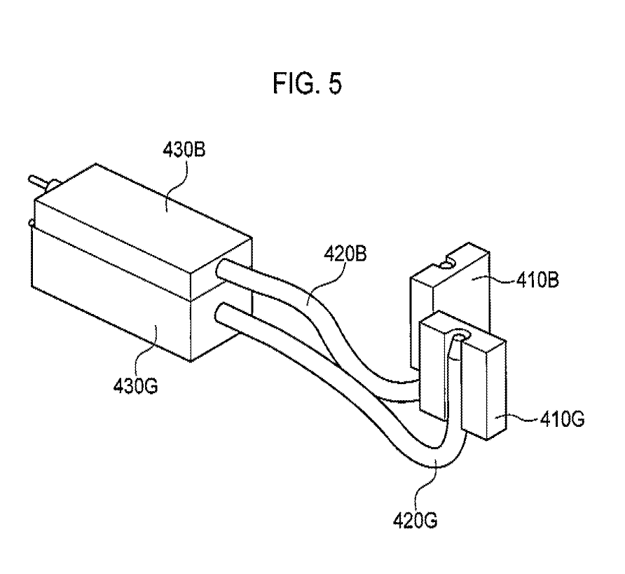

Note that the cooling unit 400G and the cooling unit 400B are an example of a cooling unit according to the specification. Moreover, the details of the cooling unit 400G and the cooling unit 400B are described later (see FIG. 5).

The cooling unit 400X cools the DMD 40. In the first embodiment, the cooling unit 400X is a cooling fin 430X.

The cooling unit 400Y cools a driver board 500 (see FIG. 4) that drives the light source 10. In the first embodiment, the cooling unit 400Y is a cooling fin 430Y.

### (Details of Cooling Unit)

In the following, the details of the cooling unit according to the first embodiment are described with reference to the drawings. FIG. 5 is a diagram that shows the details of the cooling unit 400 according to the first embodiment.

As illustrated in FIG. 5, the cooling unit 400 (the cooling unit 400G and the cooling unit 400B) includes the heat receiving portion 410, the heat pipe 420, and the cooling fin 430.

The heat receiving portion 410 receives the heat from a heat source. The heat pipe 420 transfers the heat to the cooling fin 430. The cooling fin 430 is disposed on the airflow path of air for cooling.

In other words, the heat receiving portion 410G receives the heat of the light source 10G, and the heat pipe 420G transfers the heat of the light source 10G to the cooling fin 430G. Similarly, the heat receiving portion 410B receives the heat of the light source 10B, and the heat pipe 420B transfers the heat of the light source 10B to the cooling fin 430B.

Each cooling unit 400 has a plurality of cooling fins 430. The plurality of cooling fins 430 are connected to the heat pipe 420 and disposed at predetermined intervals along an extended direction of the heat pipe 420.

### (Details of Optical Element)

In the following, the details of the optical element according to the first embodiment are described with reference to the drawings. FIG. 6 is a diagram illustrating the details of the cross dichroic mirror 20.

As illustrated in FIG. 6, the cross dichroic mirror 20 includes a first dichroic mirror 610 and a pair of second dichroic mirrors 620 (a second dichroic mirror 620A and a second dichroic mirror 620B).

The first dichroic mirror 610 has a first mirror surface 611 that reflects the blue component light B (first color component light) and transmits the green component light G (second color component light), and has a first main surface 612 formed on the opposite side of the first mirror surface 611.

The second dichroic mirror 620A is arranged on the first mirror surface 611 in such a way that the second mirror surface 621A is perpendicular to the first mirror surface 611. The second dichroic mirror 620B is arranged on the first main surface 612 in such a way that the second mirror surface 621B is perpendicular to the first main surface 612.

Note that the second dichroic mirror 620A may be adhered to the first mirror surface 611 and the second dichroic mirror 620B may be adhered to the first main surface 612. Alternately, the second dichroic mirror 620A and the second dichroic mirror 620B may be pressed against the first dichroic mirror 610 by a fixing member arranged on the outside of the cross dichroic mirror 20. In other words, the second dichroic mirror 620A and the second dichroic mirror 620B are sandwiched by a fixing member, and disposed on the first mirror surface 611 and the first main surface 612.

In the first embodiment, the gradation process for adjusting a spectral characteristic within the first mirror surface 611 is applied only for the first mirror surface 611 of the first dichroic mirror 610. Note that the spectral characteristic, for example, is adjusted by changing the film thickness of the first dichroic mirror 610.

Here, in the first embodiment, the interval between a waveband of the blue component light B and a waveband of the green component light G is narrower than that between a waveband of the red component light R and a waveband of the green component light G. Therefore, the gradation process is applied only for the first mirror surface 611 that reflects the blue component light B and transmits the green component light G.

On the other hand, a proportion of the expansion of the cutoff wavelength of the second mirror surface 621 in the wavelength interval of the red component light R and the green component light G is smaller than a proportion of the expansion of the cutoff wavelength of the first mirror surface 611 in the wavelength interval of the blue component light B and the green component light G. Therefore, even if the gradation process is not applied for the second mirror surface 621 that reflects the red component light R and transmits the green component light G, it is possible to appropriately combine the red component light R and the green component light G.

Thus, in the first embodiment, the gradation process is applied only for the first mirror surface 611 that combines the color component light having a small interval of a waveband. Moreover, the gradation process is applied only for the first mirror surface 611 that is not separated.

In the first embodiment, as illustrated in FIG. 6, the second dichroic mirror 620A and the second dichroic mirror 620B are disposed in such a way that an extended surface of the second mirror surface 621A and an extended surface of the second mirror surface 621B are deviated in a perpendicular direction (a P direction or a Q direction) of the second mirror surface 621A and the second mirror surface 621B.

The extended surface of the second mirror surface 621A may be deviated in the P direction or the Q direction, with respect to the extended surface of the second mirror surface 621B.

Here, the amount d of deviation between the extended surface of the second mirror surface 621A and the extended surface of the second mirror surface 621B is evaluated based on the following equation, for example.

$$d = \frac{a sin θ}{\sqrt{{n}^{2} - {sin}^{2} θ}} \qquad [ Equation 1 ]$$

Note that as illustrated in FIG. 6, “e” denotes an incidence angle of the green component light G for the first main surface 612. “n” denotes a refractive index of the first dichroic mirror 610. “a” denotes the thickness of the first dichroic mirror 610.

As a result, when viewed from the incident direction (R direction) of the green component light G, an overlapping region between a surface SA and a surface SB becomes the maximum on an optical path of the green component light G. Thereby, the loss of the green component light G, which occurs as a result of the passage of the surface SA and the surface SB, can be reduced.

Note that the surface SA is an interface between the second dichroic mirror 620A and the first mirror surface 611, and the surface SB is an interface between the second dichroic mirror 620B and the first main surface 612.

### (Arrangement of Light Source)

In the following, the arrangement of the light source according to the first embodiment is described with reference to the drawings. FIG. 6 is a diagram illustrating the arrangement of the light source 10.

As illustrated in FIG. 6, the light source 10G is disposed more closely to the cross dichroic mirror 20, than the light source 10B and the light source 10R. In other words, the light source 10G that outputs the green component light G which transmits through the cross dichroic mirror 20 is disposed closely to the cross dichroic mirror 20.

### (Operation and Effect)

In the first embodiment, the gradation process is not applied for the second mirror surface 621, but applied only for the first mirror surface 611. Therefore, the color component light can be combined or separated while inhibiting the rising cost.

In the first embodiment, the first mirror surface 611, for which the gradation process is applied, is a non-separated mirror surface. Therefore, the gradation process is easy.

In the first embodiment, the gradation process is applied for the first mirror surface 611 that combines the color component light having a small interval of a waveband. In other words, the gradation process is applied for the first mirror surface 611 that is strictly required for shifting the cutoff wavelength resulting from a different incidence angle of the incidence light. Therefore, the color component light can be combined appropriately.

### Other Embodiments

The present invention is explained through the above embodiment, but it must not be assumed that this invention is limited by the statements and the drawings constituting a part of this disclosure. From this disclosure, various alternative embodiments, examples, and operational technologies will become apparent to those skilled in the art.

In the embodiment, the cross dichroic mirror 20 is used to combine the color component light. However, the embodiment is not limited thereto. The cross dichroic mirror 20 can also be used to separate the color component light.

What is claimed is:

1. An optical element, comprising: a first dichroic mirror; and a pair of second dichroic mirrors, wherein
the first dichroic mirror includes a first mirror surface that reflects first color component light and transmits second color component light, and a first main surface arranged on the opposite side of the first mirror surface;
the pair of second dichroic mirrors each includes a second mirror surface that reflects third color component light and transmits the second color component light, and a second main surface arranged on the opposite side of the second mirror surface;
one second dichroic mirror of the pair of second dichroic mirrors is disposed on the first mirror surface in such a way that the second mirror surface is perpendicular to the first mirror surface;
the other second dichroic mirror of the pair of second dichroic mirrors is disposed on the first main surface in such a way that the second mirror surface is perpendicular to the first main surface; and
a gradation process for adjusting a spectral characteristic within the first mirror surface is applied only for the first mirror surface.

2. The optical element according to the claim 1, wherein an interval between a waveband of the first color component light and a waveband of the second color component light is smaller than an interval between a waveband of the third color component light and the waveband of the second color component light.

3. A projection display apparatus, comprising the optical element according to claim 1 or 2.

4. The projection display apparatus according to claim 3, wherein a light source that outputs the second color component light is disposed more closely to the optical element than a light source that outputs the first color component light and the third color component light.
